(19) United States
(12) Patent Application Publication
(10) Pub. No.: US 2018/0273044 A1
(43) Pub. Date: Sep. 27, 2018

(54) METHOD AND DEVICE FOR DETERMINING A TYPE OF THE ROAD WHICH A VEHICLE IS DRIVING

(71) Applicant: CONTINENTAL AUTOMOTIVE GMBH, Hannover (DE)

(72) Inventor: Andrei Son, Timisoara (RO)

(73) Assignee: CONTINENTAL AUTOMOTIVE GMBH, Hannover (DE)

(21) Appl. No.: 15/989,833

(22) Filed: May 25, 2018

Related U.S. Application Data
(63) Continuation of application No. PCT/EP2016/075724, filed on Oct. 26, 2016.

(30) Foreign Application Priority Data
Nov. 27, 2015 (EP) 15465561.7

(51) Int. Cl. B60W 40/06; B60W 30/09; B60W 30/12; B60W 30/14

(52) U.S. Cl. CPC B60W 40/06; B60W 30/09; B60W 30/12; B60W 30/143; B60W 2420/42; B60W 2720/10; B60W 2420/62; B60W 2420/54; B60W 2422/10; B60W 2550/141; B60W 2550/10; B60W 2420/52

(57) ABSTRACT

The invention relates to a method for determining a type of the road on which a vehicle is driving. The method comprises sensing a sound of a wheel of the vehicle which is rolling on the road by means of a microphone and/or sensing a vertical acceleration of the vehicle by means of a vertical acceleration sensor or sensing a suspension of the vehicle by means of a suspension sensor and determining the type of the road on the basis of the sensed sound and/or the sensed acceleration or the sensed suspension. Further, the invention relates to a device for carrying out the aforesaid method.

### CROSS-REFERENCE TO RELATED APPLICATIONS

This application claims the benefit of PCT Application PCT/EP2016/075724, filed Oct. 26, 2016, which claims priority to European Patent Application 15465561.7, filed Nov. 27, 2015. The disclosure of the above application is incorporated herein by reference.

### FIELD OF THE INVENTION

The invention relates to a method and a device for determining a type of the road on which a vehicle is driving, wherein the vehicle can e.g. be a car, a truck or a motorbike. The determined type of the road may be used for creating an environmental model of the vehicle, wherein the created model may be used for an Advanced Driver Assistance System (ADAS).

### BACKGROUND OF THE INVENTION

Known environmental models in ADAS currently provide data based on fused objects detected e.g. by camera, radar or laser Electrical Control Units (ECUs). Detections involved in the known environmental models are limited to objects that may be seen or that may reflect radar or laser beams.

There are elements which effect driving of the vehicle, which are in particular relevant for automated driving and which possibly are not detected with a precision of a camera, radar or laser sensor. For example, potholes may be small enough to be not detected. The same may apply for uneven road surfaces from noisy materials. Further, completely damaged roads could appear as a continuous surface of potholes.

### SUMMARY OF THE INVENTION

Thus, it is an object of the present invention to provide a method and a device for determining a type of the road on which a vehicle is driving, which provide information by use of which an environmental model may describe the environment of the vehicle with high accuracy.

The problem is solved by the subject matter according to the independent claims. The dependent claims, the following description and the drawing show preferred embodiments of the invention.

According to one aspect of the invention a method is provided which enables to determine a type of the road on which a vehicle is driving. The “type” of the road particularly refers to the type of a road surface or the type of an upper most layer of the road and the quality of the road respectively the road surface. For example the type of the road surface may be gravel, asphalt, rough tarmac, concrete, cobblestones, sand or other noisy materials. With regards to its quality the road may e.g. be clear respectively neat, bumpy, badly repaired or completely damaged. Further, the road may comprise e.g. potholes or an uneven road surface.

As one basis for determining the type of the road a sound or sounds of a wheel or wheels of the vehicle is sensed respectively are sensed, while the at least one wheel is rolling on the road. The sensing of the at least one sound is done by means of a microphone. The microphone is preferably arranged on the outside of the car, especially in the area of the at least one wheel respectively a tire of the wheel, such that the rolling sound of the wheel respectively the tire on the road may be sensed. In this context “sensing” may include capturing, in particular recording, and processing, e.g. digitalizing and transmitting, of the at least one captured sound. This step provides input data representing a particular sound of a particular type of road.

Additionally or alternatively—as another basis for determining the type of the road—a vertical acceleration of the vehicle or parts of it is sensed by means of a vertical acceleration sensor or a suspension of the vehicle is sensed by means of a suspension sensor. This step provides input data regarding vibrations or shocks, quick ups and downs in the road etc.

The “vertical acceleration” of the vehicle may e.g. be a relative acceleration of a wheel of the vehicle which may be sensed by a temporal variation of the distance between a chassis of the vehicle and the wheel, wherein the chassis particularly supports the drive, the body and the payload of the vehicle.

A body work of a vehicle in particular comprises springs, dampers, wheels and tyres and connects the chassis to the road surface via the wheels respectively tyres. The “suspension” may e.g. be the temporal change of length or compression of at least one of the springs of the body work which may be sensed by the suspension sensor.

If for example the vehicle is driving on an almost plane surface, e.g. an asphalt road with a clear respectively neat road surface, almost no or just marginal vibrations will be exposed to the wheels. As one result, there probably will be no or just a small suspension of the springs because the springs and dampers do not have to compensate for a shock but just have to compensate for marginal vibrations. As another result, there probably will be almost no relative acceleration between the chassis and the wheels. In this example, the microphone probably records almost uniform sounds with only small peaks.

But, if according to another example the vehicle is driving on a road with potholes, shocks probably will be exposed to at least one of the wheels, while the wheel is rolling into one of the potholes and while the wheel is rolling out of the pothole again. As one result, the springs will be compressed and decompressed respectively there will be a suspension of the springs because the springs and dampers have to compensate for the shock. Such a suspension may be sensed by the suspension sensor. As another result, there probably will be a relative acceleration between the chassis and the at least one wheel which may be sensed by the relative acceleration sensor. In this example, the microphone probably records noise peaks while the wheel is rolling into the pothole and while the wheel is rolling out of the pothole again.

The relative acceleration sensor may be e.g. a known gyro sensor. The suspension sensor may e.g. be a known compression sensor for springs.

On the basis of the sensed sound and/or the sensed acceleration or the sensed suspension the type of the road is determined, e.g. by means of a suitable control unit. Determining the type of the road may e.g. be realized by comparing the data representing the sensed sound and/or data representing the sensed acceleration or suspension with data representing sound profiles and/or relative acceleration respectively suspension profiles according to a specific type of a road, wherein according data may be e.g. stored in a database. The determined type of the rote may serve as a particularly suitable input for an environmental model of the vehicle in an ADAS which helps to describe the environment of the vehicle particularly realistic. The method may be implemented with low costs and low efforts and may use existing technology. Preferably, the environmental model created by the method according to the present invention is used in an Advanced Driver Assistance System (ADAS).

Preferably the determined type of the road is used as a basis for creating an environmental model of the vehicle which is driving on the road. In this regard, according to an embodiment of the invention the method may comprise a detection of fused objects in the environment of the vehicle and a detection of a condition of the road on which the vehicle is driving by means of a camera, a radar sensor and/or a laser sensor. In this context the “condition” of the road particularly refers to the condition of the road surface respectively whether there is an additional layer on the road surface. For example the road surface may be dry, wet or at least partially coated with ice, oil or another layer. This method step provides by means of a—so to say—traditional environmental model the detection respectively determination of fused objects and the road condition.

The environmental model may be created by means of the detected fused objects, the detected condition of the road and the determined type of the road. The created environmental model may take into account data of the microphone, the relative acceleration sensor or the suspension sensor in addition to data of a camera, a radar sensor and/or a laser sensor. Thus, the environmental model created by the method according to the present invention may describe the real world respectively the actual environment of the vehicle with very high accuracy and is allowing other systems to take decisions with more information available.

According to an embodiment the creation of the environmental model is additionally based on a detection of road boundaries. For example, the method according to the present invention may be used in combination with a road boundaries detection algorithm that expects to detect roads without lanes, e.g. country roads. This enables to give a comprehensive input to automated driving systems for non-highway roads.

According to another embodiment the determined type of the road supports a safety function in an ADAS. For example, the determined type of the road may be used by safety functions like Emergency Brake Assist (EBA), Emergency Steer Assist (ESA), Lane Departure Warning (LDW), Lane Keeping Assist (LKA) or Adaptive Cruise Control (ACC) to better adjust the parameters defining automated actions depending on the road surface and a degree of damage of the road as according to the detected respectively determined condition and type of the road on which the vehicle is driving.

According to another embodiment the determined type of the road supports a comfort or interior function in an ADAS. For example an Electrical Control Unit (ECU) may control a controllable suspension system of the car in a way that suspension is adapted depending on a specific determined type of the road and, thus, increase the comfort of the passengers of the car. Further, such an adapted suspension enables to reduce noise and may lead to more tranquillity inside the vehicle. Therefore, this embodiment enables to improve the quality and comfort of driving or automated driving by reducing noise created by the running respectively driving car on the particular type of road respectively road surface, and reducing shocks and vibrations of the road.

Further, the determined type of the road may be used in an ADAS, wherein the ADAS controls the speed of the vehicle depending on the detected type of the road. This may improve the safety of the car and further may contribute to a prolonging of a maintenance period of the vehicle by protecting the suspension and steering systems of the vehicle by reducing e.g. the speed if a damaged road is detected.

According to another aspect of the invention a device is provided which is adapted for determining a type of the road on which a vehicle is driving. The device comprises a microphone for sensing a sound of a wheel of the vehicle rolling on the road and/or a vertical acceleration sensor for sensing a vertical acceleration of the vehicle or a suspension sensor for sensing a suspension of the vehicle, wherein the device is adapted for determining the type of the road on the basis of the sensed sound and/or the sensed acceleration or the sensed suspension.

According to an embodiment the device is also adapted for creating an environmental model of the vehicle which is driving on the road. According to this embodiment, the device further comprises a camera, a radar sensor and/or a laser sensor for detecting fused objects in the environment of the vehicle and a condition of the road on which the vehicle is driving. The device may be adapted for creating the environmental model by means of the detected fused objects, condition of the road and the determined type of the road.

Regarding effects, advantages and beneficial embodiments of the device it is referred to the above explanations regarding the method according to the present invention, wherein the device may be adapted—if necessary with additional suitable elements—to carry out above described embodiments of the method according to the present invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following description exemplary embodiments of the invention are explained with reference to the accompanying drawing in which:

FIG. 1 shows a diagrammatic side view of a vehicle equipped with a device in accordance with an embodiment of the invention;

FIG. 2 shows a flow chart of a method in accordance with an embodiment of the invention; and

FIG. 3 shows a scheme for creating an environmental model in accordance with an embodiment of the invention.

### DETAILED DESCRIPTION OF THE PREFERRED EMBODIMENT

The following description of the preferred embodiment(s) is merely exemplary in nature and is in no way intended to limit the invention, its application, or uses.

FIG. 1 shows a vehicle in form of a car 1 which is driving on a road 2. An upper layer 3 of the road 2 is made of asphalt and, thus, provides an asphalt road surface 4 (type of the road surface) on which the car 1 is driving by means of its four tyres 5 of its four wheels 6. In a first part 7 of the road 2 which is shown on the right in FIG. 1 the road surface 4 is plane (quality of the first part 7 of the road surface 4), whereas in a second part 8 of the road 2 which is shown on the left in FIG. 1 the road 2 comprises three potholes 9 (quality of the second part 7 of the road 2). Therefore, the type of the first part 7 of the road 2 may be described as an asphalt road with an almost plane road surface and the type of the second part 8 of the road 2 may be described as an asphalt road comprising potholes 9.

The car 1 comprises a device 10 for determining the type of the road 2 on which the car 1 is driving and for creating a model of an environment 11 of the car 1 which is driving on the road 2. The device 10 comprises an ADAS camera 12 which is situated behind a windshield 13 of the car 1. In a known manner the camera 12 detects fused objects in the environment 11 of the car 1 and a condition of the road 1 on which the car 1 is driving, in this example the camera 12 detects that the road 2 is dry and not coated with ice or something else. This is a first step 100 of the method which is illustrated by FIG. 2.

The device 10 further comprises a microphone 14 which is arranged on the outside of the car 1 nearby the left front wheel 6, such that rolling sounds of the wheel 6 while driving on the road 2 are sensed. Although the microphone 14 senses sounds in the shown embodiment, the sensing of only one sound would be sufficient for determining the type of the road 2 and for creating the environmental model. The microphone 14 is a digital microphone that records sounds and transmits digital data representing the recorded sounds to a control unit 15, e.g. an Electrical Control Unit (ECU), of the device 10 which is indicated by a dashed line between the microphone 14 and the control unit 15. In the shown exemplary embodiment the control unit 15 is part of an ADAS. The described sound recording is a second step 200 of the method which is illustrated by FIG. 2, wherein the second step 200 runs parallel to the first step 100, meaning that the first step 100 and the second step 200 may be executed at the same time.

The device 10 also comprises a vertical acceleration sensor 16 which senses relative vertical accelerations of the car 1. Although the acceleration sensor 16 senses relative vertical accelerations in the shown embodiment, the sensing of only one relative vertical acceleration would be sufficient for determining the type of the road 2 and for creating the environmental model. The vertical acceleration sensor 16 is a digital sensor that transmits digital data representing the sensed relative vertical accelerations to the control unit 15 of the device 10, which is indicated by a dashed line between the vertical acceleration sensor 16 and the control unit 15. In the shown example, the vertical acceleration sensor 16 is arranged at a chassis 17 of the car 1 and senses a relative acceleration of the chassis 17 with respect to the left front wheel 6 of the car 1. This is a third step 300 of the method which is illustrated by FIG. 2, wherein the third step 300 runs parallel to the first step 100 and the second step 200, meaning that the first step 100, the second step 200 and the third step 300 may be executed at the same time.

The control unit 15 determines the type of the road 2 on the basis of the data representing the recorded sounds and the data representing the sensed acceleration. This is a fourth step 400 of the method which is illustrated by FIG. 2, wherein the fourth step 400 follows the first three steps 100 to 300. In the shown example, the control unit 15 compares the received data representing the recorded sounds and the received data representing the sensed acceleration with data representing sound profiles and relative acceleration profiles according to specific road types which are stored in a database 18 in a memory unit of the control unit 15. If the received data match with one of the stored data, then the control unit 15 determines that a road type according to the matched data is given.

In the shown example the car 1 is driving on the first part 7 of the road 2, wherein almost no or just marginal vibrations will be exposed to the wheels 6. As a result, a relative acceleration between the chassis 17 of the car 1 and the left front wheel 6 is almost zero. The acceleration sensor 16 senses this and transmits respective data to the control unit 15. Further, the microphone 14 records almost uniform sounds with only small peaks and transmits respective data to the control unit 15. Also, the camera 12 detects the condition of the road 2 on which the car 1 is driving, in this example that the road 2 is dry and not coated with ice or something else. Respective data is transmitted from the camera 12, the microphone 14 and the acceleration sensor 16 to the control unit 15 where it is compared with the stored data representing sound profiles and relative acceleration profiles according to specific road types, The control unit 15 determines that the received data match with stored data representing an asphalt road with an almost plane road surface.

If the car 1 shown by FIG. 1 is driving on the second part 8 of the road 2, shocks are exposed to the wheels 6, e.g. while the wheels 6 are rolling into the potholes 9 and while the wheels 6 are rolling out of the potholes 9 again. As a result, a relative acceleration between the chassis 17 of the car and the front left wheel 6 occurs which is sensed by the acceleration sensor 16 which transmits respective data to the control unit 15. Further, the microphone 14 records noise peaks while the wheels 6 are rolling into the potholes 9 and while the wheels 6 are rolling out of the potholes 9 again and the microphone 14 transmits respective data to the control unit 15. Also, the camera 12 detects the condition of the road 2 on which the car 1 is driving, in this example that the road 2 is dry and not coated with ice or something else. Respective data is transmitted from the camera 12, the microphone 14 and the acceleration sensor 16 to the control unit 15 where it is compared with the stored data representing sound profiles and relative acceleration profiles according to specific road types. The control unit 15 determines that the received data match with stored data representing an asphalt road which comprises potholes 9.

In a subsequent fifth step 500 of the method which is illustrated by FIG. 2, e.g. the control unit 15 creates the environmental model by means of the detected fused objects, condition of the road 2 and type of the road 2.

FIG. 3 shows in a generalized way an example of a creation of an environmental model of a vehicle which is driving on a road, e.g. the car 1 which is driving on the road 2 and comprises a device 10 shown by FIG. 1. The device 10 may—as an alternative to the vertical acceleration sensor 16 or additionally—comprise a suspension sensor 19 which may be arranged in the area of a spring of a body work of the car 1. The suspension sensor 19 may sense temporal changes of length respectively compression of the spring of the body work.

In the shown example according to FIG. 1 the car 1 is driving on the first part 7 of the road 2, wherein almost no or just marginal vibrations will be exposed to the wheels 6. As a result, there probably will be no or just a small suspension of the springs because the springs do not have to compensate for a shock but just have to compensate for marginal vibrations. The suspension sensor 19 senses this. An accordingly suspension profile may e.g. have the form of that indicated with al in FIG. 3. Further, a microphone 14, e.g. the microphone 14 of the device 10 as per FIG. 1, records almost uniform sounds with only small peaks. Also, a camera 12, e.g. the camera 12 of the device as per FIG. 1, detects the condition of the road 2 on which the car 1 is driving, in this example that the road 2 is dry and not coated with ice or something else. Respective camera data is used as an input for a first environmental model EM1. Additional input data for the first environmental model may come from an optional ADAS radar sensor 20 and/or a LIDAR sensor 21 which especially may detect objects in the environment 11 of the car 1.

The first environmental model EM1 and data from the microphone 14 and the suspension sensor 19 serve as inputs for creating a second enhanced environmental model EM2 with fusion and hearing. This second enhanced environmental model EM2 includes inter alia the type of the road (determined on the basis of the sensed sounds and suspensions) and the first environmental model EM1 which includes the condition of the road (detected by the camera 12). For example, the second enhanced environmental model EM2 includes the information that the vehicle is driving on an asphalt road with an almost plane road surface. Additionally, the second environmental model EM2 may be based on a detection of road boundaries.

If the car 1 shown by FIG. 1 is driving on the second part 8 of the road 2 shocks are exposed to the wheels 6, e.g. while the wheels 6 are rolling into the potholes 9 and while the wheels 6 are rolling out of the potholes 9 again. As a result, the springs will be compressed and decompressed respectively there will be a suspension of the springs because the springs have to compensate for the shock. The suspension sensor 19 senses this. An accordingly suspension profile may e.g. have the form of that indicated with a2 in FIG. 3. Further, the microphone 14 records noise peaks (an exemplary sound profile is indicated by a3 in FIG. 3) while the wheels 6 are rolling into the potholes 9 and while the wheels 6 are rolling out of the potholes 9 again. Also, the camera 12 detects the condition of the road 2 on which the car 1 is driving, in this example that the road 2 is dry and not coated with ice or something else. In this situation, the second enhanced environmental model EM2 includes the information that the car 1 is driving on an asphalt road which is comprising potholes 9. The second enhanced environmental model EM2 servers as an input for an ADAS of the car 1. In this situation (“car 1 is driving on an asphalt road which is comprising potholes 9”) the ADAS automatically reduces the speed of the car 1. Thus, the determined type of the road 2 supports a safety, comfort respectively an interior function in an ADAS.

The description of the invention is merely exemplary in nature and, thus, variations that do not depart from the gist of the invention are intended to be within the scope of the invention. Such variations are not to be regarded as a departure from the spirit and scope of the invention.

### REFERENCE SIGNS

1 car

2 road

3 upper layer of the road

4 road surface

5 tyre

6 wheel

7 first part of the road

8 second part of the road

9 pothole

10 device

11 environment of the car

12 camera

13 windshield

14 microphone

15 control unit

16 vertical acceleration sensor

17 chassis

18 database

19 suspension sensor

20 radar sensor

21 LIDAR sensor

What is claimed is:

1. A method for determining a type of the road on which a vehicle is driving, the method comprising the steps of:
using a microphone to sense a sound of a wheel of the vehicle which is rolling on the road;
using a vertical acceleration sensor to sense a vertical acceleration of the vehicle;
using a suspension sensor to sense a suspension of the vehicle;
determining the type of the road on the basis of at least one of the sensed sound, the sensed vertical acceleration, or the sensed suspension.

2. The method of claim 1, further comprising the steps of creating an environmental model of a vehicle which is driving on a road.

3. The method of claim 2, further comprising the steps of:
detecting fused objects in the environment of the vehicle and a condition of the road on which the vehicle is driving by using at least one of a camera, a radar sensor, and a laser sensor;
creating the environmental model by using at least one of the detected fused objects, condition of the road, and type of the road.

4. The method of claim 3, further comprising the steps of creating the environmental model based on a detection of road boundaries.

5. The method of claim 3, further comprising the steps of using the determined type of the road to support at least one safety function in an Advanced Driver Assistance System (ADAS).

6. The method of claim 1, further comprising the steps of using the determined type of the road to support at least one of a comfort function and an interior function in an Advanced Driver Assistance System (ADAS).

7. The method of claim 1, further comprising the steps of:
using the determined type of the road in an Advanced Driver Assistance System (ADAS);
using the ADAS to control the speed of the vehicle depending on the detected type of the road.

8. A device for determining a type of the road on which a vehicle is driving, the device comprising:
a microphone for sensing a sound of a wheel of the vehicle rolling on the road;
a vertical acceleration sensor for sensing a vertical acceleration of the vehicle; and
a suspension sensor for sensing a suspension of the vehicle;
wherein the device is adapted for determining the type of the road on the basis of at least one of the sensed sound, the sensed acceleration, or the sensed suspension.

9. The device according to claim 8, wherein the device is adapted for creating an environmental model of a vehicle which is driving on a road.

10. The device of claim 9, further comprising:
a camera;
a radar sensor;
a laser sensor;
wherein at least one of the camera, the radar sensor, or the laser sensor are used for detecting fused objects in the environment of the vehicle and a condition of the road on which the vehicle is driving, and the device is adapted for creating the environmental model by means of the detected fused objects, condition of the road and type of the road.

11. A method for determining a type of the road on which a vehicle is driving, the method comprising the steps of:
using a microphone to sense a sound of a wheel of the vehicle which is rolling on the road;
using a vertical acceleration sensor to sense a vertical acceleration of the vehicle;
using a suspension sensor to sense a suspension of the vehicle;
determining the type of the road on the basis of the sensed sound, the sensed vertical acceleration, and the sensed suspension.

12. The method of claim 11, further comprising the steps of creating an environmental model of a vehicle which is driving on a road.

13. The method of claim 12, further comprising the steps of:
detecting fused objects in the environment of the vehicle and a condition of the road on which the vehicle is driving by using at least one of a camera, a radar sensor, and a laser sensor;
creating the environmental model by using at least one of the detected fused objects, condition of the road, and type of the road.

14. The method of claim 13, further comprising the steps of creating the environmental model based on a detection of road boundaries.

15. The method of claim 13, further comprising the steps of using the determined type of the road to support at least one safety function in an Advanced Driver Assistance System (ADAS).

16. The method of claim 11, further comprising the steps of using the determined type of the road to support at least one of a comfort function and an interior function in an Advanced Driver Assistance System (ADAS).

17. The method of claim 11, further comprising the steps of:
using the determined type of the road in an Advanced Driver Assistance System (ADAS);
using the ADAS to control the speed of the vehicle depending on the detected type of the road.
